(19) United States
(12) Patent Application Publication
(10) Pub. No.: US 2022/0372720 A1
(43) Pub. Date: Nov. 24, 2022

(54) ULTRA-LIGHTWEIGHT FOAMED GLASS AGGREGATES FOR RESILIENCY PLANNING PROJECTS

(71) Applicant: Aero Aggregates of North America, LLC, Eddystone, PA (US)

(72) Inventors: Archibald Stewart Filshill, Huntingdon Valley, PA (US); Thomas Liam McGrath, Huntingdon Valley, PA (US)

(73) Assignee: Aero Aggregates of North America, LLC, Eddystone, PA (US)

(21) Appl. No.: 17/783,899

(22) PCT Filed: Dec. 10, 2020
(86) PCT No.: PCT/US20/64196

§ 371 Date: Jun. 9, 2022

Related U.S. Application Data
(60) Provisional application No. 62/947,216, filed on Dec. 12, 2019.

(51) Int. Cl. E02B 3/04; C02F 3/10; C02F 3/34

(52) U.S. Cl. CPC E02B 3/04; C02F 3/107; C02F 3/341; C02F 2103/001

(57) ABSTRACT

Systems and methods are disclosed for coastal resiliency amelioration or other flooding amelioration, comprising adding a layer of foamed glass aggregates to a property to raise its elevation, wherein the surcharge on an underlying soil of the property is not increased. In some embodiments, the surcharge on an underlying soil of the property is decreased (e.g., a negative surcharge). Systems and methods are also disclosed for increasing the stormwater storage capacity of a property, comprising, adding a layer of foamed glass aggregates to the property.

### CROSS REFERENCE TO RELATED APPLICATION

This application claims priority to U.S. Provisional application Ser. No. 62/947,216, the disclosure of which is incorporated by reference herein in its entirety.

### BACKGROUND

Resiliency planning is a land use concept that can have broad implications. As used herein, resiliency planning is intended to refer to contingency planning to adapt to future conditions, for example, changing climatic conditions. Resiliency planning is policy-based, and may be implemented via land use codes, zoning, development standards, incentive programs, etc. One important aspect of resiliency planning involves dealing with unwanted water (for example, stormwater runoff and storm surges).

In particular, coastal areas struggle with storm surges, a rising of water levels brought on by storms, more specifically, storm winds pushing water ashore to cause flooding. In some cases, a storm surge can raise water levels as much as 15 feet above the mean sea level, and may be exacerbated by rising tides. Given that the elevation of many coastal areas is within this range, storm surges are an important area to address. Moreover, a potential for long term rising sea levels makes this a risk that may increase over time.

Accordingly, resiliency planning for coastal areas a high priority. One solution to combat rising sea levels and/or storm surges would be to raise the grade (e.g., increase the elevation) of an affected property. However, projects for shoreline protection are heavily regulated via applicable federal, state, and local laws, ordinances, and regulations. Of particular importance in relation to adding fill to increase elevation is the concept of a surcharge load (referred to herein as a “surcharge”). Those of skill in the art readily understand the concept of a surcharge and how to determine a surcharge. Simply adding fill to a property increases the surcharge and can create a vertical load that will cause excessive settlement. Additionally, the added fill can create lateral earth pressure behind retaining walls, bulkheads, storm surge walls, or other structures. Examples of loads of particular interest to the present application include those associated with sloping retained soil projects. Accordingly, many regulators require that amelioration efforts do not increase surcharge.

Moreover, generally, fill is prohibited within a floodway unless it has been demonstrated that it will not result in any increase in flood levels, such as, for example, shunting water off to adjacent properties. Additionally, in the past, even if permitted, sites that need to add fill to raise the elevations bring in soil and typically need to perform ground improvement and/or add piles to support the weight of the added soil. Also, accommodations must be made to identify and develop areas to handle the stormwater on site.

Thus, what is needed are improved systems and methods for increasing the elevation of a property with minimal surcharge and, optionally, while increasing stormwater storage capacity.

### SUMMARY

Systems and methods are disclosed for coastal resiliency amelioration or other flooding amelioration, comprising adding a layer of foamed glass aggregates to a property to raise its elevation, wherein the surcharge on an underlying soil of the property is not increased. In some embodiments, the surcharge on an underlying soil of the property is decreased (e.g., a negative surcharge).

Systems and methods are also disclosed for increasing the stormwater storage capacity of a property, comprising, adding a layer of foamed glass aggregates to the property.

### BRIEF DESCRIPTION OF THE DRAWINGS

FIG. 1 depicts foam glass aggregates, such as ultra-lightweight foamed glass aggregates (UL-FGA).

FIG. 2A depicts a diagram of a coastal property that has had its elevation raised with a layer of UL-FGA.

### DETAILED DESCRIPTION

Systems and methods are disclosed for increasing the elevation of a property with minimal surcharge and, optionally, while increasing stormwater storage capacity. For example, systems and methods are disclosed for coastal resiliency amelioration or other flooding amelioration, comprising adding a layer of foamed glass aggregates to a property to raise its elevation, wherein the surcharge on an underlying soil of the property is not increased. In another example, systems and methods are disclosed for increasing the stormwater storage capacity of a property, comprising, adding a layer of foamed glass aggregates to the property, provided that the surcharge on an underlying soil of the property is not increased.

Foam glass aggregates are an inert, stable, and environmentally friendly substrate. Typically, to form foam glass aggregates, recycled glass is cleaned, ground, mixed with a foaming agent, heated, and allowed to fragment from temperature shock. The resulting aggregates are cellular, with a relatively low bulk density, but relatively high durability. Foam glass aggregates have many uses, for example, as a lightweight fill for construction applications, vehicle arrestor beds, building insulation, etc. However, since foam glass aggregates provide an important economic driver for glass recycling, finding new uses and applications for foam glass aggregates is extremely desirable.

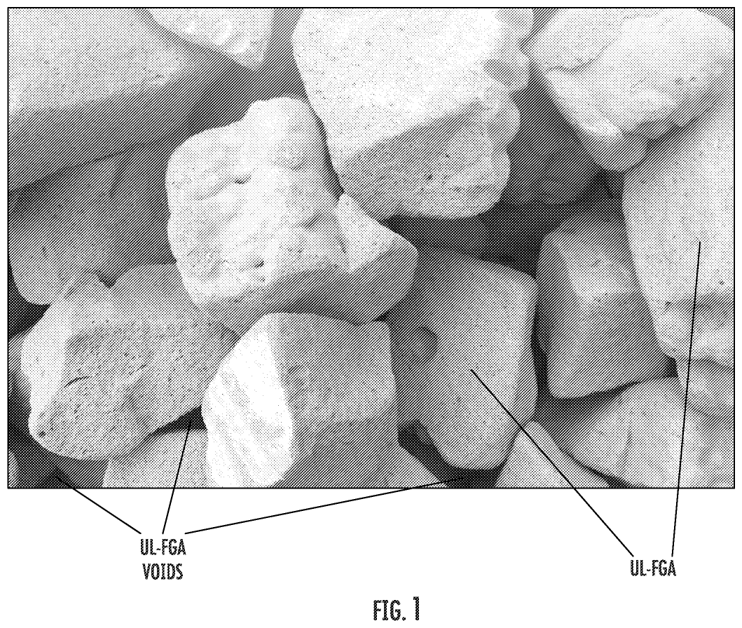

FIG. 1 depicts a type of foam glass aggregates, referred to herein as ultra-lightweight foamed glass aggregates (UL-FGA). As can been seen in FIG. 1, UL-FGA particles are quite angular, and as a result, the interaction of the various UL-FGA particles defines voids between the particles (“UL-FGA voids).

Suitable UL-FGA may be procured from AERO AGGREGATES, Eddystone, Pa. The UL-FGA may be prepared from a recycled glass cullet. The UL-FGA may be prepared from a sodo-calic glass. As UL-FGA is made up of silica, it may be considered a natural material for regulatory purposes. As UL-FGA is made from recycled glass, it may be considered environmentally friendly. Alternatively, UL-FGA may be prepared from waste glass (e.g., byproduct from glass manufacture) or other glass particles, for example, glass that is other than post-consumer recycled glass. UL-FGA properties include low unit weight, low thermal conductivity, high strength, non-absorbent, non-toxic, non-leachable, chemically stable, impervious to UV degradation, freeze/thaw stable, and fireproof.

Certain UL-FGA properties are particularly beneficial when used to increase the elevation of a property (e.g., a coastal property), such as, for example, UL-FGA is highly frictional (e.g., once compacted, UL-FGA is unlikely to shift with time), UL-FGA is non-leaching, UL-FGA is chemically inert (e.g., safe), UL-FGA is rot-resistant (in fact, UL-FGA is rot proof), UL-FGA is non-flammable, UL-FGA is durable (e.g., UL-FGA does not degrade when used in this application), and UL-FGA is rodent resistant (e.g., resists burrowing animals and insects). Moreover, as will be described below, the interaction of the various UL-FGA particles defines voids between the particles that have been found to be particularly advantageous for stormwater storage.

In a first example, the UL-FGA may have an open cell structure. Open cell foamed glass is produced by using a different foaming agent than that used for closed cell foamed glass. The foaming agent for open cell reacts faster in the heating process and creates inter-connections between the air bubbles which allow water to be absorbed into the aggregates. The UL-FGA with an open cell structure may, in particular, have pores to support growth of microbes and bacteria (such as, for example, to aid in water quality amelioration).

In a second example, the UL-FGA may have a closed cell structure. It is understood that UL-FGA, as used in this disclosure, comprises both open cell or closed cell structures unless specified as one or the other.

UL-FGA (e.g., either open cell UL-FGA or closed cell UL-FGA) may be combined with water treatment media (such as, for example steel slag, calcium carbonates, organoclays, etc.) that removes phosphates, nitrates, and/or hydrocarbons. The water treatment media may be a coating, dusting, or otherwise applied to a surface of the UL-FGA. In a preferred embodiment, the UL-FGA is a closed cell UL-FGA having organoclay deposited on its surface.

The UL-FGA may have a particle size of about 5 mm to about 80 mm, preferably, about 10 mm to about 60 mm. Upon installation, the UL-FGA may have a bulk density of about 120 kg/m³ to about 400 kg/m³, preferably about 170 kg/m³ to about 290 kg/m³, and more preferably about 200 kg/m³ to about 240 kg/m³.

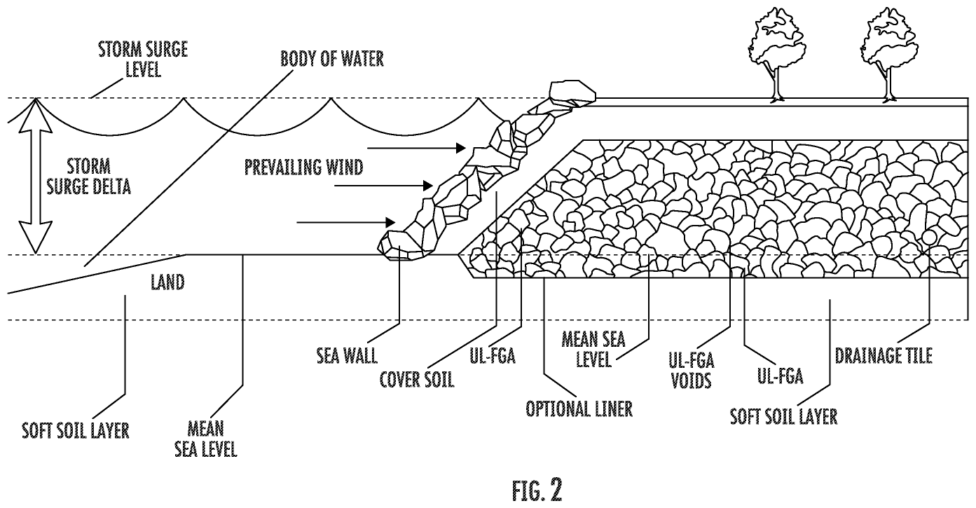

Turning to FIG. 2, a coastal property is depicted. For purposes of this disclosure, a “coastal property” is intended to broadly refer to a property adjacent to a body of water (e.g., ocean, sea, lake, lagoon, slough, etc.). As can be appreciated. “adjacent to” need not be limited to a portion of the property touching (e.g., being partially bounded by) the body of water. As used herein, “adjacent to” only requires that the property is 50 feet or less above the average level of the body of water and within 50 miles of the body of water. In a preferred embodiment, “adjacent to” refers to land that may be impacted by a storm surge from the body of water. In that example, “adjacent to” refers to land that may be within about 8 feet to about 10 feet above the current sea level, especially within about 3 feet to about 4 feet above the current sea level. In another preferred embodiment, “adjacent to” refers to land that may be within a flood plain associated with the body of water. In that example, “adjacent to” refers to land that may be within a 100 year flood risk. Insurance companies conventionally associate proximity to a body of water with flooding risks, and in this sense, another example of “adjacent to” refers to land that may be within an increased flooding risk associated with the body of water.

The body of water has a mean sea level (regardless of whether it is salt, fresh, or brackish water) which can be readily determined by those skilled in the art. The body of water may experience a storm surge (or other flooding event). In the example of FIG. 2, a storm surge is created by the prevailing winds during a storm pushing water ashore. A storm surge level is associated with the storm surge. The storm surge level can be determined by historical data or can be predicted based on modeling. The difference between the mean sea level and storm surge level is the storm surge delta. Although not depicted, the storm surge delta could be replaced by an estimate of rising sea levels in the future and still fall within the scope of the disclosure. As mentioned above, the disclosure also contemplates flooding consistent with a position of the land in a flood plain, which can be determined by historical data or can be predicted based on modeling.

The coastal property of FIG. 2 had an initial elevation (not pictured) in relation to the mean sea level, but as illustrated, the property has had its elevation raised with a layer of UL-FGA. The layer of UL-FGA may be from about 1 foot to about 10 feet thick (e.g., measured vertically). Preferably, the layer of UL-FGA may be from about 1 foot to about 7.5 feet thick. More preferably, the layer of UL-FGA may be from about 2 feet to about 4 feet thick. The layer of UL-FGA does not require a foundation. As illustrated in FIG. 2, a layer of soil (e.g., a soft soil layer) is disposed under the UL-FGA.

A layer of cover soil is disposed above the UL-FGA. The UL-FGA stabilizes the layer of cover soil. For example, UL-FGA has a residual friction angle greater than about 50 degrees, greater than about 52 degrees, preferably about 54 degrees. For comparison, common gravel has a residual friction angle of about 45 degrees and is a stable base to place soil over (however, as can be readily appreciated, gravel's weight makes it unsuitable for a use where surcharge is regulated). In an example, a portion of the cover soil can be excavated from the property. In another example, a portion of the excavated soil may be hauled away to offset the weight of the UL-FGA layer. Since UL-FGA is extremely light compared to soil, a relatively small amount of removed soil will offset many yards of UL-FGA. As mentioned above, it may be desirable to haul off more than an offset amount of soil, in order to create a negative surcharge, as will be discussed.

As illustrated, the property soil has been excavated below the mean sea level. UL-FGA is non-leaching, chemically inert (e.g., safe), rot-resistant (e.g., rot proof), non-flammable, durable (e.g., UL-FGA does not degrade when used in this application), and rodent resistant (e.g., resists burrowing animals and insects). UL-FGA can be submerged underwater (e.g., including saltwater) with no deleterious effects. The UL-FGA may have a first moisture constant when placed, but after coming in contact with water, may have a second moisture content at equilibrium.

Alternatively, the property soil need not be excavated below the mean sea level.

An optional liner may be disposed between the UL-FGA and the soft soil layer. The optional liner may be a permeable liner. The optional liner may be a semi-permeable liner. The optional liner may be an impermeable liner. Suitable impermeable liners include those made from reinforced polyethylene, reinforced polypropylene, thermoplastic olefin, ethylene propylene diene monomer, polyvinyl chloride, isobutylene isoprene, butyl rubber, etc. The optional liner may be, or may incorporate, a bentonite clay liner or other geosynthetic clay liner.

A layer of UL-FGA may be placed as loose aggregates and then compacted. The layer of UL-FGA may be used for all load classes. The layer of UL-FGA may be placed up to 450 without additional reinforcement. A sea wall is illustrated to prevent erosion of the cover soil and/or UL-FGA, such as, for example, by the action of waves. The sea wall may be replaced by a retaining wall, bulkhead, storm surge wall, or other structure.

The layer of UL-FGA may be associated with a minimal surcharge to the underlying soils. The layer of UL-FGA may be associated with a minimal surcharge to the underlying soils due to its low unit weight. As compared to gravel, the layer of UL-FGA may be about 80% lighter. For example, a foot of soil (which weighs about 120 lbs/cf (or pounds per square foot (psf)) can be excavated and replaced by 5-6 feet of UL-FGA (which weighs about 20 lbs/cf (or psf) per foot) with no additional surcharge on the underling soils. Even after compaction, the elevation would be raised considerably.

In an example, a layer of UL-FGA is added to a site and the surcharge is not increased (for example, by offsetting the load from the UL-FGA by removing an equivalent weight of excavated soil). In another example, a layer of UL-FGA is added to a site and the surcharge is only minimally increased (e.g., 80% less than the surcharge would be increased by the same cubic feet of soil). In another example, a layer of UL-FGA is added to a site and the surcharge is decreased (e.g., by removing a portion of excavated soil), also referred to herein as a negative surcharge. By way of a nonlimiting example, replacing a foot of soil with 5 feet or less of UL-FGA will create a negative surcharge.

The UL-FGA layer allows rainwater, storm surge, or other water, to pass through the layer of UL-FGA, preventing the cover soil from becoming overly saturated. Other drainage systems, such as drainage tile, may be implanted in conjunction with the UL-FGA layer. Additionally, the UL-FGA layer possesses considerable insulation properties. As a result, the UL-FGA layer acts to prevent sub-soils from freezing, which is beneficial for promoting water infiltration (e.g., and water table recharge), even in cold climates. Advantageously, the drainage tile, if present, may also remain efficacious year-round (e.g., even in winter).

UL-FGA voids in the UL-FGA layer have been found to be particularly advantageous for stormwater storage. Even after compaction, the UL-FGA layer may contain greater than 25%, greater than 30%, greater than 35%, or about 40% void space, which provides additional stormwater storage and promotes water infiltration. In an example, UL-FGA may be approved for stormwater storage. Accordingly, by using UL-FGA, a coastal property owner can raise the elevation of the site, eliminate the need for foundations, and have added capacity for stormwater storage.

In a first embodiment, a method of coastal resiliency amelioration is provided, comprising, adding a layer of foamed glass aggregates to a coastal property to raise its elevation, wherein the layer of foamed glass aggregates provides stormwater storage. In some aspects of the method, the surcharge on an underlying soil of the property is not increased. In some aspects of the method, the layer of foam glass aggregates is about 1 foot to about 10 feet thick. The method preferably further comprises excavating a portion of the property before adding the layer of foamed glass aggregates. In this preferred embodiment, the surcharge on an underlying soil of the property is not increased, and wherein at least one cubic foot of soil from the excavation is removed from the property for every five cubic feet of foamed glass aggregates added. In an aspect of this preferred embodiment, the surcharge on an underlying soil of the property is decreased. Optionally, the method (including the preferred embodiment) further comprises placing a liner under the layer of foamed glass aggregates. Optionally, the method (including the preferred embodiment) further comprises placing a layer of cover soil over the layer of foamed glass aggregates. In some aspects of the method, the foam glass aggregates have a particle size of about 5 mm to about 80 mm. In some aspects of the method, the foam glass aggregates have a bulk density of about 120 kg/m³ to about 400 kg/m³ at a first moisture constant. In some aspects of the method, the foam glass aggregates are prepared from a recycled glass cullet. In some aspects of the method, the foam glass aggregates have pores to support growth of microbes and bacteria. In some aspects of the method, the foam glass aggregates are treated with a water treatment media.

In a second embodiment, a method of increasing the stormwater storage capacity of a property is provided, comprising, adding a layer of foamed glass aggregates to the property. In some aspects of the method, the surcharge on an underlying soil of the property is not increased. In some aspects of the method, the surcharge on an underlying soil of the property is decreased. In some aspects of the method, the layer of foam glass aggregates is about 1 foot to about 10 feet thick. In some aspects of the method, the layer of foam glass aggregates is about 2 feet to about 4 feet thick. In some aspects, the method further comprises excavating a portion of the property before adding the layer of foamed glass aggregates. In this case, the surcharge on an underlying soil of the property is not increased, and wherein at least one cubic foot of soil from the excavation is removed from the property for every five cubic feet of foamed glass aggregates added. In a preferred aspect, the surcharge on an underlying soil of the property is decreased. In some aspects, the method further comprises placing a liner under the layer of foamed glass aggregates. In some aspects, the method further comprises placing a layer of cover soil over the layer of foamed glass aggregates. In a preferred aspect, the cover soil may be a portion of the soil excavated from the property.

In a third embodiment, a use of foamed glass aggregates to raise an elevation of a property without increasing a surcharge of the property is provided. In some aspects, the foamed glass aggregates are open cell foamed glass aggregates. In some aspects, the foamed glass aggregates are closed cell foamed glass aggregates. In some aspects, either the open cell foamed glass aggregates or the closed cell foamed glass aggregates have been treated with a water treatment media. In some aspects, the water treatment media is one or more of a steel slag, a calcium carbonates, or an organoclay.

In a fourth embodiment, a use of foamed glass aggregates to decrease a surcharge of a property is provided, comprising excavating a portion of the property to remove its soil; and replacing a portion of the removed soil with a layer of foamed glass aggregates, provided that the net weight of the removed soil is greater than the net weight of the a layer of foamed glass aggregates. In some aspects, the foamed glass aggregates are open cell foamed glass aggregates. In some aspects, the foamed glass aggregates are closed cell foamed glass aggregates. In some aspects, either the open cell foamed glass aggregates or the closed cell foamed glass aggregates have been treated with a water treatment media. In some aspects, the water treatment media is one or more of a steel slag, a calcium carbonates, or an organoclay. In some aspects, the layer of foamed glass aggregates provides stormwater storage. In some aspects, the elevation of the property is (e.g., is also) raised.

### EXAMPLES

### Example 1

Recycled glass cullet is cleaned, ground to less than 150 micrometers (US Standard sieve size No. 100), mixed with a foaming agent (e.g., for open cell UL-FGA, a carbonate foaming agent; for closed cell UL-FGA, a silicon carbide foaming agent) in a blending unit, heated, and allowed to fragment from temperature shock. The resulting UL-FGA is cellular. After sample preparation, the initial moisture content is measured following ASTM D2216 (2010), grain size distributions are determined following ASTM C136/136M (2006) and the initial bulk density is measured following ASTM C127 (2012a) on the UL-FGA. The average moisture content is determined to be 1.06% (initially, the moisture content will be lower (although if exposed to moisture the UL-FGA can hold up to 10% by volume on its surface)) and the average bulk density is determined to be 227.2 kg/m³ (14.2 pcf). Sieve analyses are performed following the dry sieving method on the UL-FGA. Particle size ranges from 10 to 30 mm (0.39 to 1.18 in) but is a very uniformly graded material.

### Example 2

Recycled glass cullet is cleaned, ground, mixed with a foaming agent, heated, and allowed to fragment from temperature shock. The resulting UL-FGA is cellular (foaming creates a thin wall of glass around each gas bubble). By volume, UL-FGA is approximately 92% gas bubbles and 8% glass. The water content (per ASTM D 2216) of UL-FGA will change with time due to the cellular nature of the material as the exterior ruptured pores are filled with water and varies from 2% (when contacting water) to 38% after being completely submerged for several days.

### Example 3

A site is raised about 4 feet in elevation by excavating 2 feet of soil, hauling away 1 foot of soil, adding a 5-foot layer of UL-FGA, and covering the layer of UL-FGA with 1 foot of the previously excavated soil. This example neglects the elevational impact of compaction for simplicity of explanation. Those skilled in the art can readily determine the amount of loose aggregate required to raise the elevation while accounting for compaction. No surcharge is added to the underlying soils. The layer of UL-FGA provides stormwater storage.

### Example 4

A site is raised about 5 feet in elevation by excavating 1 foot of soil, adding a 5-foot layer of UL-FGA (after compaction), and covering the layer of UL-FGA with the previously excavated soil. Adding 5 feet of UL-FGA is associated with less surcharge than adding 1 foot of soil, and, as compared to adding five feet of soil, minimal surcharge is added to the underlying soils (e.g., 83% less weight). Also, the layer of UL-FGA provides stormwater storage, whereas soil would not.

### Example 5

A site is raised about 5 feet in elevation by excavating 4 feet of soil, hauling away 3 feet of soil, adding a 8-foot layer of UL-FGA (after compaction), and covering the layer of UL-FGA with 1 foot of the previously excavated soil. This results in a negative surcharge (e.g., a net reduction in weight) even as elevation is increased (for example, 120 psf×3 feet of soil is replaced with 20 psf×8 feet of UL-FGA (resulting in a net reduction in weight)).

1. A method, comprising:
adding a layer of foamed glass aggregates to a property, wherein the layer of foamed glass aggregates provides increased stormwater storage capacity.

2. The method of claim 1, wherein the surcharge on an underlying soil of the property is not increased.

3. The method of claim 1, wherein the surcharge on an underlying soil of the property is decreased.

4. The method of claim 1, wherein the layer of foam glass aggregates is about 1 foot to about 10 feet thick.

5. The method of claim 1, further comprising excavating a portion of the property before adding the layer of foamed glass aggregates.

6. The method of claim 1, further comprising placing a liner under the layer of foamed glass aggregates.

7. The method of claim 1, further comprising placing a layer of cover soil over the layer of foamed glass aggregates.

8.-10. (canceled)

11. The method of claim 1, wherein the foam glass aggregates have pores to support growth of microbes and bacteria.

12. The method of claim 1, further comprising treating the foam glass aggregates with a water treatment media.

13.-15. (canceled)

16. The method of claim 1, wherein the layer of foam glass aggregates is about 2 feet to about 4 feet thick.

17.-25. (canceled)

26. A method, comprising:
excavating a portion of a property to remove a portion of soil; and
replacing at least part of the removed soil with a layer of foamed glass aggregates, provided that the net weight of the removed soil is greater than or equal to the net weight of the layer of foamed glass aggregates.

27. The method of claim 26, wherein the foamed glass aggregates are open cell foamed glass aggregates.

28. The method of claim 26, wherein the foamed glass aggregates are closed cell foamed glass aggregates.

29. The method of claim 26, wherein the foamed glass aggregates have been treated with a water treatment media.

30. The method of claim 29, wherein the water treatment media is one or more of a steel slag, a calcium carbonates, or an organoclay.

31. The method of claim 26, wherein the layer of foamed glass aggregates provides stormwater storage.

32. The method of claim 26, wherein the elevation of the property is raised.

33. The method of claim 26, further comprising placing a liner under the layer of foamed glass aggregates.

34. The method of claim 26, further comprising placing a layer of cover soil over the layer of foamed glass aggregates.

35. The method of claim 26, wherein the surcharge on an underlying soil of the property is not increased or is decreased.
